(19) United States
(12) Patent Application Publication
(10) Pub. No.: US 2011/0295694 A1
(43) Pub. Date: Dec. 1, 2011

(54) SYSTEM AND METHOD FOR AN INDIVIDUAL DATA MARKETPLACE AND MONETIZATION

(76) Inventors: John COGGESHALL, Pontiac, MI (US); James Dilorenzo, Sag Harbor, NY (US); Kevin Dorry, Sparta, NJ (US); John Houston, New York, NY (US); Gordon Trotter, Sagaponack, NY (US); David Andrew Stackpole, Greenwich, CT (US); Yen Tse Yap, Kuala Lumpur (MY)

(21) Appl. No.: 13/096,569

(22) Filed: Apr. 28, 2011

Related U.S. Application Data
(60) Provisional application No. 61/328,865, filed on Apr. 28, 2010.

(51) Int. Cl. G06Q 30/00

(52) U.S. Cl. 705/14.66; 705/14.71; 705/14.69

(57) ABSTRACT

A platform or marketplace for individual users to store, control, maintain ownership over, and monetize data related to themselves and their activities. The platform or marketplace facilitates company offers, such as product offers from producers, to members on mutually agreeable contract terms, facilitating mass connection of individual users. The platform or marketplace facilitates protected communication, third part advertising, member payment, and various other functions related to user data ownership and individual monetization.

### CROSS-REFERENCE TO RELATED APPLICATIONS

This application claims the benefit, under 35 U.S.C. §119(e), of U.S. Provisional Patent Application No. 61/328,865, filed Apr. 28, 2010, the entire contents of which is hereby incorporated by reference in its entirety.

### BACKGROUND

Generally, the marketplace for consumer data currently excludes the consumer. Data collection is a multi-billion dollar industry built around companies obtaining consumer data for profiling, marketing, and research purposes. The origins of this industry pre-date digital technology. However, the Internet, computers, and information technology in general, has facilitated the collection of vast amount of consumer data. Consumer data may include, but is not limited to the following: demographic information, financial information, purchasing history, social networking particulars, website browsing history, web search history, consumption of media content. Companies may collect, analyze, and sell this data to businesses who sell products or services to consumers. Many companies use this data and data-related services to decide how to allocate their marketing and advertising dollars. The consumers have neither an easy means to limit access to their data or shield themselves from this data collection, nor do they have a means to monetize this very valuable information that others are obtaining about them.

Consumers currently can communicate with businesses on a company-by-company basis by calling, writing, emailing, visiting the business' premises to request information, to issue complaints, to purchase, or to deal with general customer service issues. Companies can reach individuals in generally similar ways to sell their products or services. However, consumers do not currently have a means to convey information to multiple companies simultaneously or dynamically.

Currently advertising and marketing messages are served to the consumer generally based on what the marketer estimates to be the most relevant message at that time. This holds true for a variety of media advertising, including television, magazines, radio and web-based (e.g., display and search). The consumer does not currently have a universal tool to communicate to companies and publishers what advertising that consumer would like to see at that particular moment. Therefore the relevancy of specific ads served to consumers may be generally suboptimal and inefficient for both parties (consumer and advertiser).

Companies currently attempt to extrapolate consumer purchase intentions primarily through indirect means (e.g., using methods that circumvent the consumer) from a variety of data sources. These data sources may use dated information about the consumers that are mere snapshots profiled from the consumer's behavior in the past. Additionally, this data is generally collected and analyzed independent of the consumer's input. For example, a company may collect data on visitors to their sports website, and the dataset may reveal that the most statistically probable visitor of a sports information website is a 24.5 year old male. A dataset collected from 16 to 33 year old males may reveal that males in this age range, (i.e. 16 to 33 years old) are most likely to purchase one or more types of products. The data may thus reveal the most efficient advertising campaign based on this limited data may be to show those types of products on that example website. While this may be more efficient than showing ads at random, there is currently very little done to cater to a single individual visitor, which may leave advertising campaigns with the potential for greater efficiency in targeting.

Companies today do not have direct access to a continuous stream of real-time information provided by the consumer. They also do not have the means to directly reach an individual consumer in response to that consumer's changing real-time data. For example, if a consumer's tire on his car bursts, he is now a prime customer for tire companies. However, he currently cannot convey this information to multiple tire companies simultaneously and instantly. The tire companies, similarly, have no automated way of knowing specifically that this particular consumer needs a tire fairly urgently.

### SUMMARY

Example embodiments of the present invention may provide a platform for individual consumers to efficiently interact with individual companies (“brands”) while maintaining anonymity. The platform may provide a unique interface to each individual user to connect to a dynamic data repository that stores data about the user. The user may be provided with management tools to have total control over the stored data associated with the user. Each individual user may have a value score associated with their dataset, based on a number of factors, including determinations by a data verification module. The platform may provide to corporate users (e.g., companies, brands, etc.) tools and interfaces for specifying specific consumer targets and/or brand targets. The platform may then facilitate the leasing of access to user data by the companies based on the specific consumer targets. The lease price may be based on user input, company input, and/or the value score. Access to data may be facilitated by the platform in such a way as to keep users completely anonymous with respect to companies, and when desired, vice versa. Companies may also solicit information from users (e.g., survey questions) via the platform, to provide tailored individual communication with total anonymity.

Other example embodiments of the present invention may include a targeted advertising system where users may enter their own data, permit the passive collection of their data, and/or state their purchase intentions. The user's self-entered data may be verified using one or more methods. Each user may be given a value score, based on their participation (e.g., how much of the user's data the user has entered or allowed to be passively collected), a profile (e.g., what the user's actual data is), verification (e.g., how much data has been verified to be correct), the user's stated purchase intentions and verification of how accurate those purchase intentions were, as compared to subsequent verifiable action.

Example embodiments may allow users to lease or sell access to their data to third parties, receive offers from third parties, view advertising from third parties, and/or perform a number of functions for compensation. Offers may be matched based on match criteria from companies and data associated with users. Additionally, offers may be matched by minimum ask prices by users and maximum bid prices by companies. Offers may include visual and/or audible advertisements, survey questions, single questions, interactive games, tasks to perform, videos, emails, messages, or any number of other action or item a party may pay a user to perform or receive.

Example embodiments may display received and collected information about a user to that user, and may organize the information and the display of that information. Example embodiments may pay the user according to the matched offers, and may also keep a fee separate from the offer or part of the offer payment. A value score may be associated with a user which may guide or determine the cost of leasing access to a user's data or submitting an offer to a user. The value score may be presented to the user, and/or one or more translations of the value score may be presented to the user (e.g., a users rank based on value score). In one example embodiment, users may be paid monthly for access to their data by various companies (e.g., as compared to conventional “paid per click” models). The access fee to companies may be based on a user value score, which may be based on the quality and quantity of that user's interaction.

Example embodiments may allow third party content providers to partner with the system. The third party content provider may use conventional advertising target algorithms to match a display ad with a website visitor, based on demographic, behavioral, and/or psychographic characteristics of the most statistically probable visitor to the website. One example system may, when a system user visits the third party content provider, replace the conventionally-matched ad with a user-specific ad matched by the system, which may provide greater revenue streams for the third party content provider.

Various other example embodiments, combinations of embodiments, and variations of embodiments are also possible.

### BRIEF DESCRIPTION OF THE DRAWINGS

FIG. 1 illustrates an abstract system diagram, according to one example embodiment of the present invention.

FIG. 2 illustrates a dataset grid, according to one example embodiment of the present invention.

FIG. 3 illustrates a user intention grid, according to one example embodiment of the present invention.

FIG. 4 illustrates one example flow diagram between three entities, according to one example embodiment of the present invention.

FIG. 5 illustrates one example system, according to one example embodiment of the present invention.

FIG. 6 illustrates one example method, according to one example embodiment of the present invention.

FIG. 7 illustrates one example user dataset, according to one example embodiment of the present invention.

FIG. 8 illustrates another example user dataset, according to one example embodiment of the present invention.

FIG. 9 illustrates an offer grid, according to one example embodiment of the present invention.

FIG. 10 illustrates an offer interface, according to one example embodiment of the present invention.

FIG. 11 illustrates a third part content provider arrangement, according to one example embodiment of the present invention.

FIG. 12 illustrates one example flow diagram between four entities, according to one example embodiment of the present invention.

FIG. 13 illustrates another abstract system diagram, according to one example embodiment of the present invention.

### DETAILED DESCRIPTION

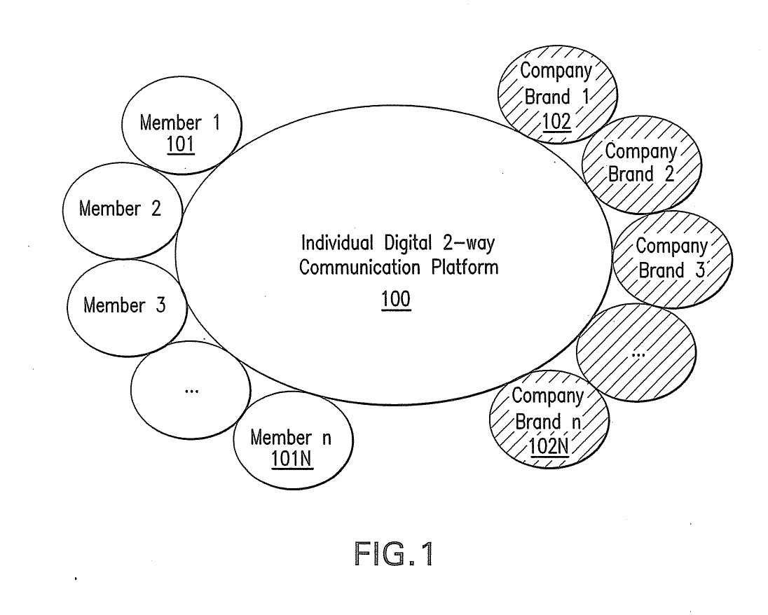

Example embodiments of the present invention include a platform and/or marketplace for the buying, selling, collecting, and delivering of access to data related to each individual, for a plurality of individuals. FIG. 1 may generally illustrate the broad structure of example embodiments of the present invention. An example embodiment of the present invention may include a communication platform 100, to bring together information providers (e.g., members 101 to 101N) with information purchasers (e.g., companies 102 to 102N). Further, example embodiments may provide the market and controls for facilitating the exchange of information for compensation.

Example embodiments of the present invention may allow each individual user, for a plurality of users, to enter information describing that respective user. There may be various types of descriptive data, such as core data, behavioral data, and/or user-intention data. The user may be given total control over what kinds of data are collected and the data values that are collected. On the other side, third-parties such as advertisers and/or providers of products/services may be allowed to purchase access to sets of data, and/or provide offers and advertisements based on the data. In order to facilitate an individual experience for a user, while allowing providers to access large sets of users, example embodiments may implement various forms of a bid/ask marketplace. For example, each user may specify a willingness to view a thirty second advertisement for some amount of money (e.g., $0.50) or more. A provider who wants to advertise a product, may issue a video ad offer to a certain set of users (e.g., men, 18 to 35, within 10 miles of some address, who make at least $50,000 a year) for a specified price (e.g., $0.75). This general arrangement may apply to an array of various offer platforms that participate in the system. Example embodiments of the present invention may include an array of features, which are described below in the context of various example embodiments.

### Example Embodiment Components

Data Collection: Example embodiments of the present invention may utilize several types of data, and several methods of data collection. For example, an individual user, also referred to herein as a member, may actively enter his or her (hereinafter “their”) data, e.g., age, gender, zip code, hobbies, and purchase intentions into an account belonging to that user. Data pertaining to descriptive facts, e.g., age, gender, zip code, etc., may form a first type of data for a user, e.g., “core data.” More subjective user-provided data, such as hobbies, may form a second type of data for a user, e.g., “supplemental data.” Data such as purchase intentions may form a third type of data, e.g., “intention data.” This intention data may be user provided and may indicate several variables, such as: an intention or desire to purchase some type of product (e.g., a car or a washing machine), a level of desire/intention (e.g., “will purchase” to “might purchase”), and a timeframe (e.g., will purchase sometime in the next 90 days). The member may also allow the system to passively collect and collate data as another type of descriptive data, e.g., allowing the system to track his Internet browsing activity or his purchasing information, e.g., via financial accounts. In one example embodiment, all forms of passive data collection may require affirmative permission of the user, who may maintain complete control over what is collected and how long the information is stored.

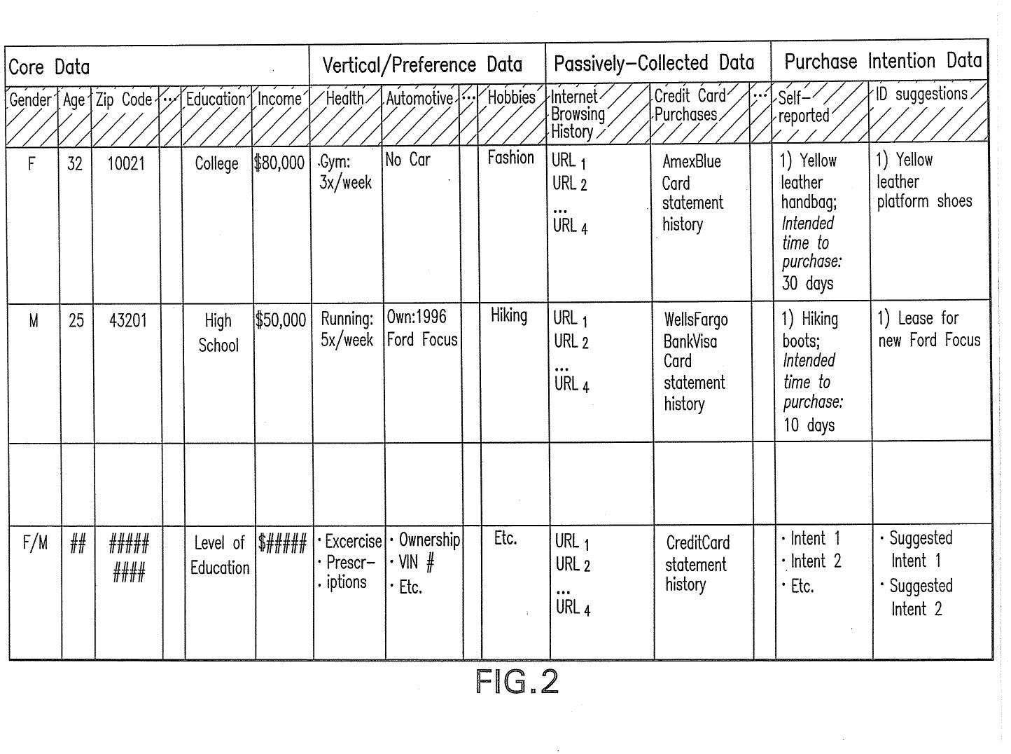

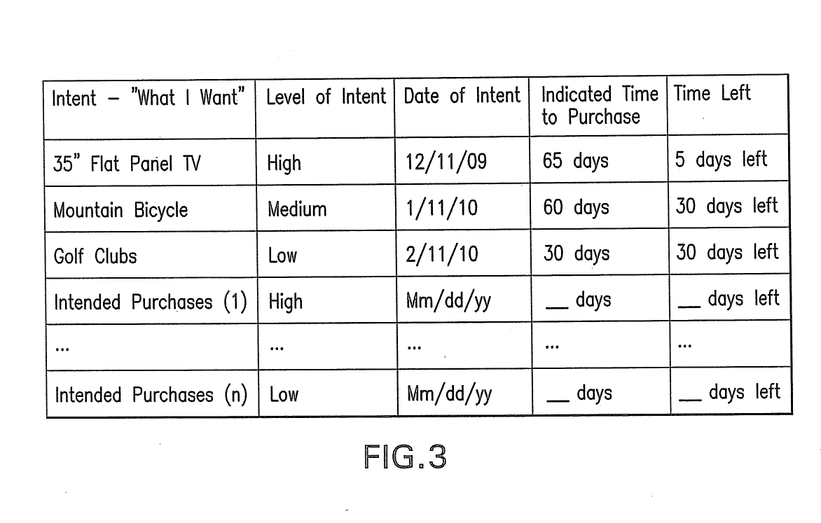

FIG. 2 illustrates an example subset of member data, illustrated in a table data structure. The example data of FIG. 2 is categorized into four major segments. In this example, the four major categories of data are: (i) core data, e.g., data that is commonly-used to describe a particular demographic, such as age, gender, income, education, marital status, number of children, etc.; (ii) vertical/preference data, e.g., data that describes a particular industry or interest group, such as healthcare, automotive, hobbies, etc.; (iii) passively-collected data, e.g., data that is collected by the system on behalf of the member (with their permission), such as Internet browsing history data or credit card statement data showing their purchase history; and (iv) purchase intention data, e.g., data that relates to a member's purchasing intentions over a stated period of time. Any number of other data elements and/or data categories are also possible in different implementations of the present invention. The data can either be self-reported by the member or suggested by the system. Purchase intentions that are suggested by the system may be confirmed by the member before it is entered into the database. Furthermore, purchase intent data can also refer to immediate/near-term intentions to purchase (known as “in-market” intentions) or more aspirational purchase desires. FIG. 3 illustrates one example table of stored intention data. The table of FIG. 3 may illustrate intentions for one member, with each row representing a different intention. The example system may collect this information from the member, including the type of purchase desired, “intent,” the level of intent or likelihood of purchase, the date the record was created or the date of intent, a timeframe for when the intended purchase may occur, and the some calculation of remaining time with respect to the previous two elements.

0 Member Controls: Example embodiments may provide a number of controls for providing data, reviewing data, allowing passive data collection, verifying data, and generally providing total control over a member's data. An example embodiment may therefore act as a secure digital repository for each members' data, and such data may be regarded as the property of the associated member, since the example embodiment may allow the member to control access to this data with a comprehensive set of controls. In addition to permissions over what types of information is collected, users may control what companies or third-parties have access to their information. First, as will be described further below, users may monetize their data in a number of ways, e.g., via a bid/offer (also referred to as a bid/ask) marketplace. However, users may additionally specify criteria beyond financial requirements. For example, a member could choose to only permit companies that abide by fair trade principles or only health and beauty product companies to access that member's data. Member controls may also allow the member to partition data into various segments, e.g., completely private, only accessible by certain types of companies, fully accessible, etc.

Company Interface: In this context, an example embodiment of the present invention may include third-party users, e.g., advertisers, product/service providers, content providers, etc. (herein referred to generally as “companies”). Companies may be able to perform searches using filters against data categories to obtain a highly-targeted audience of members for their brand messages and/or promotional offers. For example, using FIG. 2 as an illustration, a fashion designer company releasing a new line of leather handbags can either perform a filtered search for their particular target customer, e.g., females in the 23-45 age group, with incomes of above $50,000. In this search, the company's resulting target group may include Member 1. At this point, the company may access Member 1 and others in its target group to send a highly relevant brand or promotional message to them. This message may range from a simple email to an immersive and interactive video advertisement to a promotional offer. In an example embodiment, the offer is only delivered to the resulting member, if that member's controls allow for the type of offer (e.g., type of company, format of offer, price of offer, etc.), as specified in the member controls. The company could also search for members who are in the market for a “handbag,” e.g., those members who have expressed an intent to buy a handbag. In this case, Member 1's self-reported intent to purchase a “yellow leather handbag” has been tagged by the system to include the keyword “handbag” so if a company searches for members who are intending to purchase a handbag, Member 1 may show up in the list of results. The company could then send a highly-targeted message to this list of members.

Cooperative Data Collection: Example embodiments of the present invention may present a system where individuals are able to directly and cooperatively develop their profiles. For example, with member permission, the example system may analyze the member's Internet browsing history and work with the member to develop an accurate profile of him or her. In this case, if the example system “observes” that the member has visited many website with a “hockey” theme, then the example system may suggest to the member that he is a hockey enthusiast. The member may confirm this as being true (or false). Further, the example system may present follow-up questions, such as, degree of interest, specific team(s), etc. As another example, if the system observes that the member has visited many “jewelry” websites, it may suggest that the member was interested in jewelry, but the reason the member visited many jewelry websites may be because the member was interested in buying jewelry for a gift, and not because the member would otherwise be interested in jewelry. This distinction is achieved with the example system's cooperative framework for developing a member's profile.

Cooperative Data Collection (Purchase Intentions): In other example embodiments of the present invention members may be able to report directly to companies that they are “in the market” for a particular product or service and have the company more efficiently direct the relevant offers or brand messages to them when they are most receptive. FIG. 3 may illustrate a user data set of intent data. A member may simply state her intent to purchase a product or service. For example, Member A may enter into the example system her intent to purchase a bicycle. The member may also indicate the level of desire to purchase (e.g., “high”, “medium,” or “low”) and the period in which she thinks she will make the purchase (e.g., “within 30 days”). In another example embodiment, a member may also see computer-generated intent, based on identified patterns in his or her profile data or browsing habits etc. For example, if Member A's browser plug-in reads that he has visited many bicycle-themed websites in the past 10 days, the example system may automatically ask Member A whether he is in the market for a bicycle, e.g., the next time he logs into the system. Member A may then answer positively or negatively; if the former, the intent may be recorded by the example system, and he can subsequently state the level of his desire and the intended purchase period.

Offer-Based Searching: In addition to purchase intentions, a user may search based on criteria, e.g., item type and price range. Then, a member may either see what offers are immediately available, or return to the system later to see what offers are presented to him. Thus, in-market searching via stated intentions not only allows for immediate search results of offers or brand messages related to the search terms that are already in the example system's database, but also allows companies to respond directly to a member's search. For example, a member may be interested in purchasing a yellow leather handbag. This member may enter the search term “yellow leather handbag” in an in-market search box, and may specify the price range interested in, e.g., “$200-$500”. Next, the member may further specify that they are looking to purchase the handbag within the next 30 days. The information that the member has entered may now be conveyed to the companies on the example system through an alert system that is either automatic (e.g., generated by the system) or set up by the companies themselves (e.g., to be alerted for certain keywords). Companies may therefore design specific offers to send to the member based on that member's in-market search criteria.

Additionally, the member may now have a new, more efficient way to search through results, since she does not have to sift through the results immediately nor does she have to see the same search results each time. In-market search may introduce the elements of (a) individuality to the search results—companies can target specific offers to a member, (b) time, in that results may be viewed immediately or later, as more offers populate the members' search results, (c) efficiency—since members could not only communicate their desires directly to companies, but may also search through the offers when they are in the mindset to search, at their own pace, and in non-overlapping segments.

Value Scoring: Example embodiments of the present invention may include a value score for each member's dataset. The value score may be based on three general categories: (1) the actual data entered, (2) the type and quantity of data entered, and (3) verification of that data. For example, a user may enter core data, such as age, gender, zip code, etc. This may provide that user with a base value, for example, “1.” This user may then choose to enter their income and their credit score. It may be the case that knowing what a recipients income is provides some value, e.g., 0.2, while knowing what a recipient's credit score is provides some other value, e.g., 0.5. In this example, as one example embodiment of the value score calculation, the user's value score could now be a sum of the parts, e.g., 1.7. This may be an example of “(2) the type and quantity of data entered,” in that companies value the “income” type of data at a certain rate and the “credit score” type of data at another rate, while entering both provides more value than either one alone (e.g., quantity). Quantity values could also be affected by a more complete answer, such as income over time.

As for “(1) the actual data entered,” companies may associate different values with different types of people, as represented by the actual data values associated with those people. For example, sellers of large ticket items (e.g., luxury car dealers) may be interested in high income individuals, while sellers of bargain items (e.g., off-brand or outlet clothing) may be more interested in middle-income individuals. The interest levels of companies, including how much they are willing to pay for information and how many customers are willing to receive offers based on that information may determine the value associated with that information.

Value Ticker: There may also be a value ticker, which may be a direct representation of the value score, a translated representation of the value score, or some other component of a user's profile. The value ticker may be an easy reference point for users to know the value of their profile asset (e.g., their dataset). The ticker may be able to represent this value in various forms, e.g., (i) amount of dollars that can be made immediately, (ii) value of all earnings made since becoming a member, or since last week, last month, last year, etc., (iii) value of all matching offers in the entire marketplace, (iv) value of the user based on his or her projected future earnings within the example system, or any number of other arrangements for illustrating, publically and/or privately, a form of the user's value score. Like a stock market ticker, the value ticker may also serve as a reference point for users to know the value of other users on the system, which is useful for gauging the value of one's own profile asset. Nonetheless, the level of public visibility of the ticker will be at the control of the user, so he may choose to make his ticker public or visible only to selected groups or people.

Value Scoring (Verification of Data): The third example value score component may be “verification of data.” For example, a user may state their credit score as being between two values, (e.g., a stated FICO™ of 720-740). This user may be awarded a value for answering this question and another value (whether combined or separate) for having a high score, e.g., +0.1. Further, if the member is willing to verify their credit score via one or more methods of verification, that member may be entitled to an additional value, e.g., +0.5. However, if a score is verified, and found to be inaccurate, that user may receive a reduction in their value score for that aspect. Through permission of the member, and data sharing relationships with various database maintainers, virtually any and every piece of data may be verified. For example, income, family size, marital status, employment length, home ownership, charitable giving, style of investing, net worth, and many other data points may be verified or approximately verified with a member's permission and a data sharing relationship with tax preparing software companies, IRS databases/form requests, and online investment broker accounts, among others. Purchases at a macro level—and eventually at the micro level—may be verified with credit card companies.

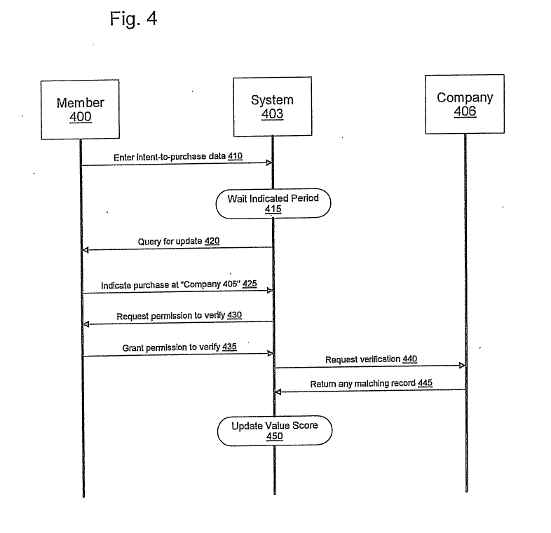

Information sharing arrangements may also be in place with retailers. Since many of the companies with verifiable purchase data may be provider-companies of an example embodiment, arrangements may be made to discount fees for those companies, if they share purchase data for verification purposes. FIG. 4 provides an example of this feature. A member 400 may indicate an intent to purchase an item (e.g., a dishwasher) in some timeframe (e.g., 1 month), which is illustrated in communication 410 to the example system 403. The example system may allow the user to indicate the purchase has been made at any point, and/or at 415, the system 403 may wait for the stated time period (e.g., 1 month) to expire. This does not have to be exactly the stated time period, as the system may request an update at any time (e.g., a week before expiration). At 420, the system 403 may prompt the user for an update (e.g., purchased, decided against purchase, within another month, etc.). After the user 400 indicates the item has been purchased, e.g., at 425, the system 403 may check to see if the indicated location (e.g., company 406) has a data sharing agreement, or otherwise provides verification data. If so, at 435, the system 403 may request permission to verify the purchase, which may be given at 435. The system 403 may then request verification from company 406, at 440. At 445, company 406 may then return any records matching information provided in 440. In this regard, system 403 may have sent along the customer's name, or the credit card number the customer indicated was used for the purchase, etc. Finally, at 450, the system may update the member's value score.

In this way, members who indicate an intent to purchase some item may have their score increased because they become more valuable to providers of those products. However, this small value boost will quickly be eliminated or even made negative if verification fails some number of times, as the customer is either maliciously incorrect or merely unreliable in articulating their purchase intentions. This benefits the companies by ensuring the quality of individuals accessed (communicated with) on the system, and also benefits the accurate and honest users, by making their verified data even more valuable.

### EXAMPLE EMBODIMENTS

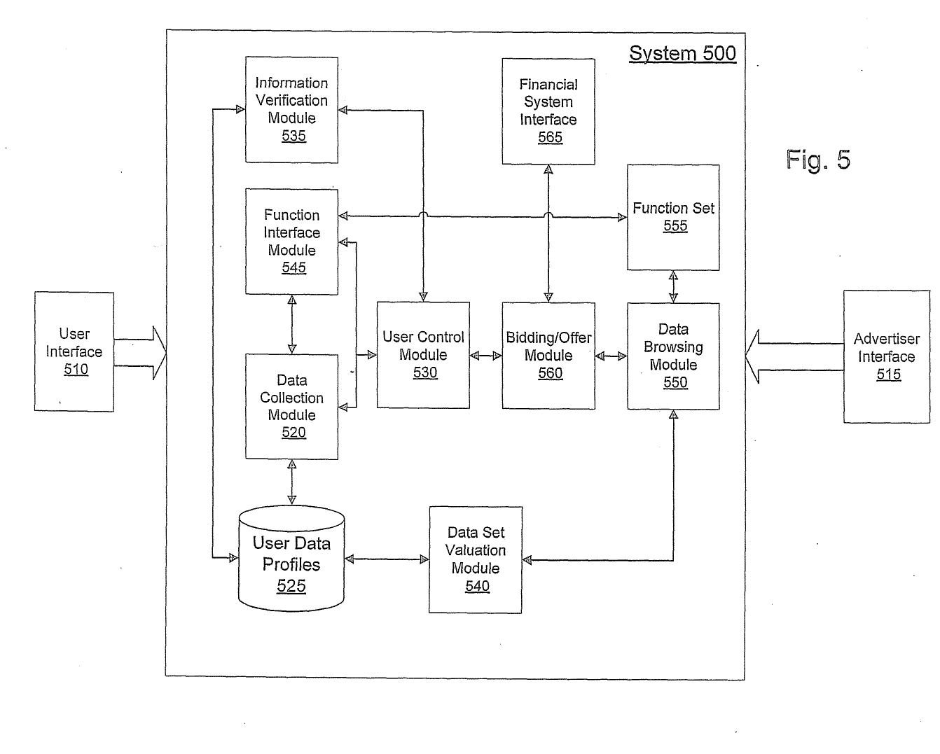

FIG. 5 illustrates one example embodiment of an example information exchange system and marketplace. Example system 500 may provide an interface for both members, e.g., 510, and companies, such as advertisers, e.g., 515. The example system 500 may include a data collection module 520, which may provide one or more interfaces for the users to enter data or grant permission for data collection. The example system 500 may include a data repository 525, which may include one or more storage devices at one or more locations. The user may be provided one or more data controls with a control module 530. Here, the user may grant permissions, delete data, modify settings, modify asking/offer prices for data access, configure interfaces, and otherwise control aspects and features of the example embodiments. The example system may have a data set valuation module 540, which may calculate a value for each individual member, based on one or more parameters. The example system may have an information verification module 535, which may facilitate one or more methods of verifying provided and/or collected information.

On the other side, example system 500 may provide a data browsing module 550, for companies to interface with the set of data modules. The companies may also be provided a function set 555, which may include one or more functions for presenting advertisements and/or offers (e.g., as described in one or more of the example embodiments). The function set 555 may interface with a function interface module 545 on the user side of example system 500. The function interface module 545 may connect with user control module 530 so the user may opt-in to one or more offer presentation functions and thereby monetize their data. The example system 500 may also include a bid/offer module, which may facilitate the matching of members' asking price for access to communicate with them, and companies' bid/offer amount for certain data. As such, module 560 may perform a central component to the information monetization marketplace feature. The marketplace functions, e.g., 560, may interface with a financial system interface 565, which may facilitate payment to the members. Payment to the users may occur in a number of ways, including online gift cards, automated clearing house payments to a linked account, reloadable debit cards (such as those issued by major credit card companies) that may be reloaded by module 565, check printing/mailing systems, etc.

The bid/offer marketplace may be one example embodiment or may be one aspect/feature of another example embodiment. Further, in one example embodiment, customers may be paid the ask/offer price specified, in a paid-per-offer configuration. In another example embodiment, customers may not receive direct pay-per-offer or pay-per-click compensation, but rather have their value score go up by participation, which may increase their monthly lease revenue. In this respect, a bid/ask marketplace may also be provided for datasets, where users may specify the ask price for a company to lease access to their dataset and to their participation within the context of the example embodiments.

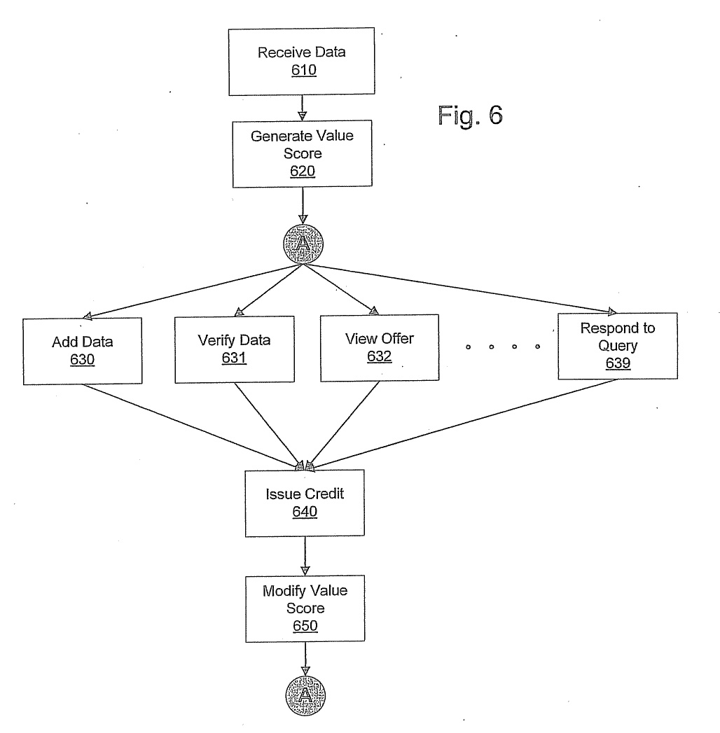

FIG. 6 illustrates one example procedure for operating an aspect of one example embodiment. At 610, the example procedure may receive data, e.g., from the user or via user-approved passive collection. New data may generate an initial value score for that user, e.g., at 620. The user may next interact with one or more functions, e.g., add more data 630, verify data 631, view an offer 632, and/or respond to a query 639. Responsive to performing one of these actions, the example procedure may issue a credit, e.g., $0.25. This may be immediately loaded onto a reloadable debit card, it may be stored in an internal account for future withdrawal, or any number of other payment arrangements could be fashioned in various implementations of example embodiments. Additionally, a user's value score may be modified, based on the category of function (e.g., adding data at 630) or the result of performing the function (e.g., the actual data given at 630). The user may then perform additional functions as much as desired (e.g., as illustrated at marker “A”).

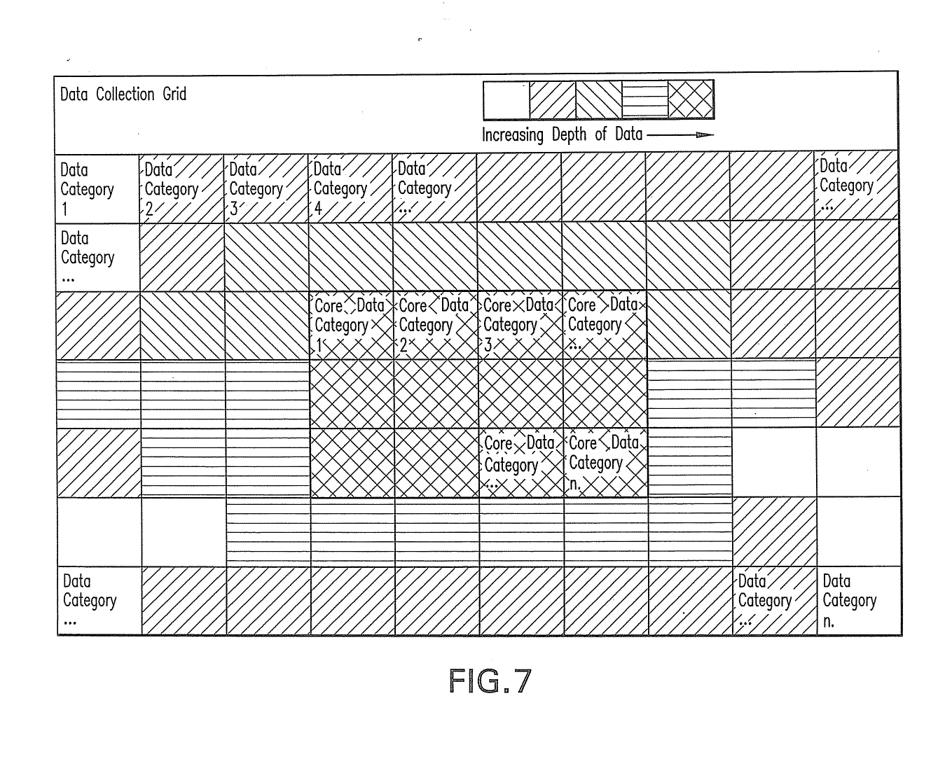

In an aspect of one example embodiment, the user may be provided the opportunity to add data to their profile to increase an associated value parameter. FIG. 7 illustrates a matrix of data stored with a user profile. Each category and level of data may provide a different degree of information, and likewise, a different level of value. For example, a user may receive a certain value for “core data” (e.g., in the darker center part), a second value for outlying data, and a third value for data between these two categories. From the entered data, e.g., both what data slots are filled and what the specific value they are filled with, a value score for the entire data set may be constructed. This data-set value score may be used for several functions. First, it presents a user with a summed metric related to how much and how well they are interacting with the platform. Further, it provides the user a relative basis for evaluating additional interaction with the system (e.g., a first action may raise a score by X, while a second action may raise the score by 3×). Additionally, it may provide companies a relative metric for evaluating users, and also a metric for determining the cost of leasing access to a data set.

In one or more example embodiments, data presentation may be an important feature. An aspect of these example embodiments may be member trust in the integrity of the system with regard to their data. Members may be provided one or more ways to visualize and inspect every aspect of their collected data, both actively collected or passively collected. FIG. 7 is one such illustration. The illustrated grid may increase in size over time, e.g., in two dimensional directions, as individual elements are added. Additionally, the illustration of FIG. 7 may be three dimensional, with each square being a collection of data. In this case, FIG. 7 may be a top view of square columns, each with a height relevant to the amount of data in that set. In another example embodiment, the depth of data in a particular node may also be indicated, e.g., in a deeper color, so that the entire view of the grid will consist of varying degrees of color that relate to the amount and richness of information provided (or collected).

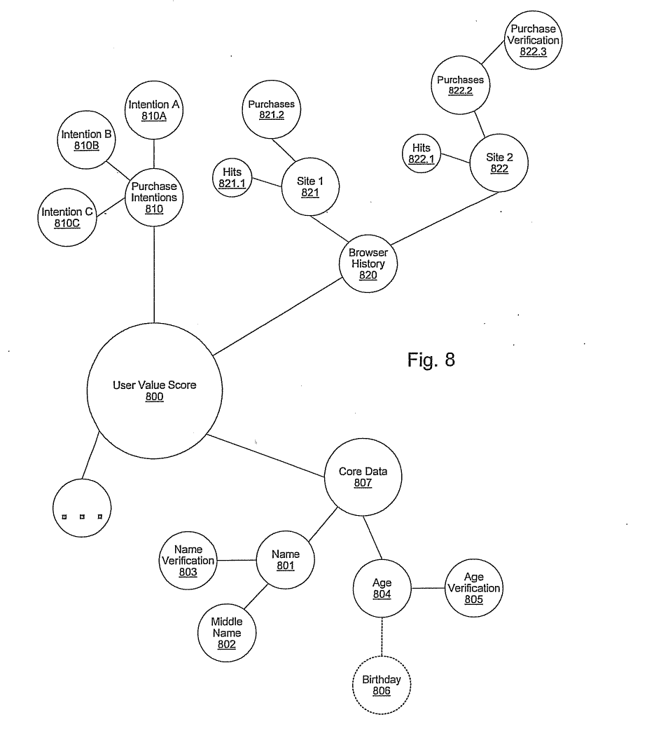

Other example implementations of this aspect are also possible. For example, FIG. 8 shows another example of a graphical representation of a user's data set. FIG. 8 may illustrate a growing tree of data, with the user's value score 800 anchoring a center or starting point. This is only one example, any other data point, or non-data starting point could also be used. Branching off may be core data 806, with some instances of core data, such as name 801 and age 804. Branching from those may be additional information, such as middle name 802, and verification records 803 and 805. Here, optional data item 802 is shown as a leaf/branch of the name element, but could also be included in node 801. The example user interface of FIG. 8 may also provide suggestions of other information a user could add. For example, birthday 806 is illustrated as a leaf/branch of age 804, but is outlined in dashed lines, indicating the user may click on this item and add data here. Purchase intention data is illustrated at 810, with leaves 810A to 810C. This user's data set also has a browser history 820 illustrated, containing two sites, e.g., 821 and 822. Data elements 822.1 and 821.1 may indicate the number of times the user visited that site. Element 821.2 may indicate one or more purchases made at the site. Purchase(s) 822.2 may have been verified, and a record of that verification may be leaf/branch 822.3.

In an example embodiment, a data category may have an enormous amount of data elements, e.g., browser history 820. For some users, instead of two visited sites 821 and 822, a user may have thousands, millions, or more, depending on the length of time the history is stored and the activity of that user. In this case, an example embodiment may show some quantity of the most visited sites, e.g., the 10 most visited sites. The example embodiment may also have another element “other sites” (not shown), which may show some quantity of additional sites when expanded. Another example embodiment may employ additional branches by creating organizing nodes, such as a browser history node per day of the current week, a node for all of last week, last month, last year, etc. The growing tree graphical interface may grow immensely in various directions, and may be illustrated in two dimensions or three dimensionally. The user may be able to rotate the interface along one or more axes. The tree nodes may also be sized according to content and/or distance from the center. In this way, if too much information exists to display it all, various zoom levels may be provided according to which larger nodes the user selects while navigating the data set.

Dataset representations may also hide some of the data that is likely not interesting to the user. The data may be hidden by collapsing certain groups of data into an umbrella node, or by simply not representing that data on the visualization. However, in one example embodiment, a user may be provided a “reveal all” function, that ensures the user has the ability to see the totality of their dataset, regardless of any data being hidden by default. In addition to being able to zoom in/out, collapse/expand, and reveal/hide data, a user may also be able to delete any data and be provided a “flush” function that purges the system of all data related to that user. Robust dataset controls may be important for assuring the user that they own their data and may use example embodiments with confidence that they control every aspect of the use of their data.

FIGS. 7 and 8 illustrate two example embodiments of graphical dataset representations, but any number of other representations are also possible. In these examples, the user may gain confidence that all of the information being collected about the user is visible and controllable. If a node pops up the user is uncomfortable with, the user may click on that node and delete or modify it. Some data may only be deleted and not modified, such as verification records. Further, if a user finds a data element they object to, the user may be provided information on where it came from and what settings could be adjusted to prevent the collection and storage of that type of data.

The example embodiment of FIG. 7 may provide a unique and engaging interface for members to control, add, and edit their personal data. This interface may include various views, where a member's profile data may be arrayed in a series of nodes arranged in a display structure, e.g., a grid. One view, which may be the default or starting view, may include the entire image or a fully “zoomed out” view of the data grid. In this view, a member may see the entire grid for a full view of her personal data “map’, with her core demographic data at the center of this map. Nodes representing the aspects of her life that are more important, or more valuable (to an advertiser), could be arrayed closer to the center of the grid. This full grid may be an ever-growing map since a person's data is potentially infinite.

A data viewing function may provide a zoomed in view, where a member may be able to view a section of the grid by category, section, area, etc. Members may be able to zoom in to a single node and its contents. The member may work in this view format to input, edit, or delete data. Data from individuals may be collected in a fun and engaging method employing visual graphics (e.g., in the form of icons), games, leading questions, or any number of other engaging functions to elicit involvement. For example, data may be added by members by playing games that are provided on example embodiments of the system, which may call on members to use their data. The game may be connected to the member's data collection grid, so that data entered is synced up either way. Data entry is also encouraged by a system of positive feedback (e.g., through increased value in the individual's ticker, value score, or a game-like reward experience). The Data Collection Grid of FIG. 7 may form the basis of the example platform's data collection methods.

Example embodiments of the present invention may provide the user with several varying opportunities for data monetization. There may be a passive data monetization, e.g., selling or leasing access to datasets or parts of data-sets in exchange for one-time or monthly payments. Additionally, members may receive compensation for participating in programs that may replace pre-existing ads (e.g., banner ads on content sites) with specific dataset targeted ads (e.g., ads targeted at that member specifically). Further, users may receive compensation for receiving direct-delivery offers and advertisements (e.g., email offers). Example embodiments of these, and other data monetization procedures, are described below.

In one example embodiment, a user may lease access to their data to various companies.

In this embodiment, the data set value score may directly relate to the final cost of that data. Alternatively, the value score may merely help users and companies evaluate how much they want to ask for and offer respectively, for the use of that data. For example, a market research company may want the browser history of 21 to 24 year old men who have expressed an interest in purchasing a motorcycle. The company could put out an offer to this set of users, who may review and accept, or have preset acceptance rules (e.g., accept offers over $X). The company may then pay those users the stated monthly fee for a duration previously agreed upon (e.g., 4 months), or for an open-ended duration (e.g., until cancelled by either party). A company may pay more to lease on-going data (e.g., from users currently recording their browsing history), as compared to leasing historical data. Further, users may be able to set the lease terms. In this example embodiment, users may collect monthly payments without ever engaging in more active features (e.g., ad clicks or email promotions). Companies may also bid on segments of data. For example, a company may only want to know the political party affiliation of users aged 30 to 35. A user may accept a smaller sum of money to lease access to just this segment of data, depending on preferences set by the user controls.

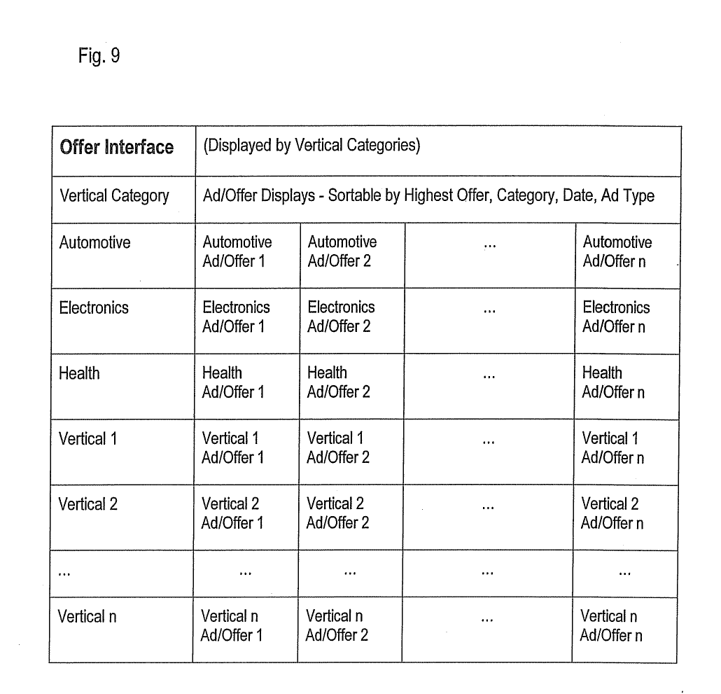

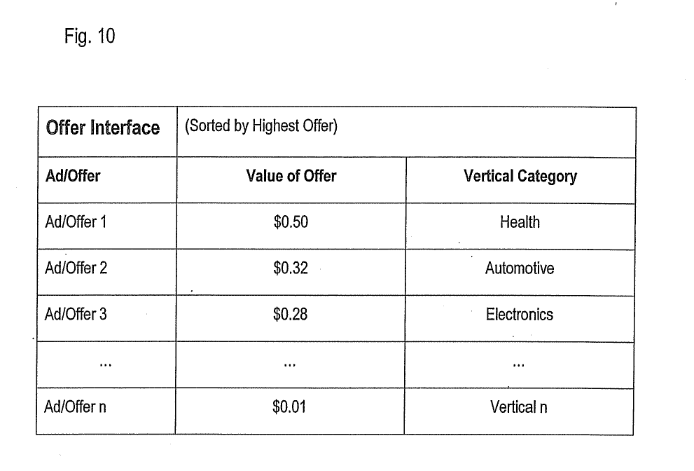

In addition to leasing data, in one example embodiment, customers may monetize their data by participating in offers targeted to their dataset. An offer interface may include a direct communication interface for companies to deliver ads and offers to individuals. The interface may be designed to engage the individual and may dynamically change to show the types of ads and offers that the individual would be interested to see, based on that individual's dataset. In one example embodiment, at least some of the ads and offers may be presented in a manner that requires the individual to engage with the ad, in order for there to be an exchange of value from the advertiser to the individual. For instance, an ad may require the individual to click on it before the promised payment is made to the individual for viewing it. Ads and offers may be sorted by various categories, including highest offer first, industry verticals, time to expiration, etc. For example, FIG. 9 may illustrate a grid of offers, organized by dataset category, while FIG. 10 may illustrate a list of offers organized by offer price. These offers may include any number of things, such as single image ads, audio ads, multi-image ads (e.g., flash, video, or other multimedia displays), or may request a service be performed, such as filling out a survey or answering a question. In one example embodiment, survey questions and answers may add to a user's dataset. In some embodiments, dataset additions based on surveys may require the survey provider's permission and/or the user's permission.

In order to facilitate the protection of member data, which may be regarded as fully owned by the member, while allowing member-to-company interaction, example embodiments may provide anonymous message exchange. All members may have a common interface to communicate with various brand members (e.g., companies). Likewise, all brands may have a common interface to communicate with members. Example systems may maintain each member's anonymity throughout the communication between brands and members. Example systems may first take delivery of messages from one party (e.g., a member or company), remove unnecessary identifying information (e.g., email address), and then deliver anonymously to the other party. Replies may likewise be sent, with example systems maintaining and protecting the information necessary to deliver a reply, without divulging that information to the other parties. Some members may choose to sell their contact information to companies, while other members may prefer the security of knowing that information cannot be misused (e.g., used beyond the terms of a sale/lease arrangement).

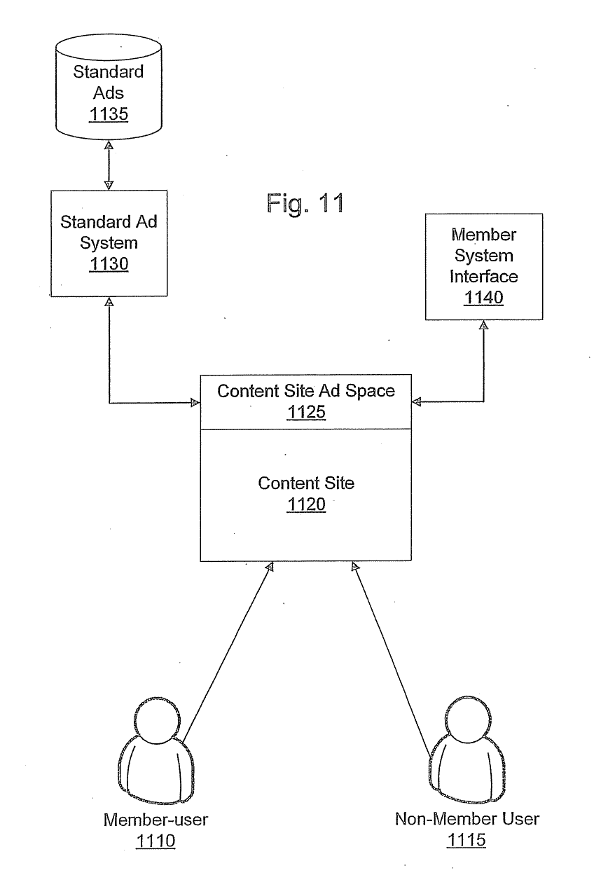

In addition to browsing various offers, users may automatically screen out or accept offers. For example, a user may set a minimum offer price for a single message ad, screening out all lower offers, and routing all higher offers to their inbox (or separate offer box). Further, automatic screening may be the default for certain content ads, or enhanced conventional ads. FIG. 11 may illustrate an example of this arrangement. Several content sites exist on a “free with advertising” business model. For example, online newspapers, blogs, and other information content sites use banner ads, pop-up/under ads, and varying other ad displays. Content providers such as free streaming television (e.g., www.hulu.com) have break points where short presentation or interactive advertising is placed. As illustrated in FIG. 11, there may be a content site 1120 (e.g., an online newspaper) with a banner ad 1125. This site may have conventional ad contracts, where an advertiser pays some amount of money per ad display (e.g., $5 per 1000 impressions), or pays some amount of money per click. Content site 1120 may continue to draw from it database of conventional ads 1135, via its conventional ad interface 1130, whenever a conventional user, e.g., non-member user 1115 visits the content site.

Additionally, as an enhancement of the conventional ad display arrangement, the content site 1120 may participate in example embodiments of the present invention, and have an additional connection to member system interface 1140. Member system interface 1140 may connect (e.g., via the Internet) to example embodiments of the present invention to draw advertisements. For example, member/user 1110 may navigate to content site 1120 (e.g., via link, directly, via search engine, etc.). That site's ad display program may be coded for interaction with example systems, may have installed a plug-in provided by example systems, or example systems may leverage cookie reading features already part of the banner display system. Regardless of method, content site 1120 may identify the current visitor 1110 as a member of the data marketplace system. This may be done via cookies or other conventional identifying and state-saving devices. It may also be done in ways more unique to the example system described herein. One data-point of a member, stored in that member's dataset, may be one or more media access control address(es), Internet Protocol address(es), and/or other hardware or software identifiers. Upon a new member reaching a content site, that content site may query the marketplace system to see if the incoming identifier is associated with a member. In some scenarios, a permanent address may be stored for a member. Other times, the system may store an IP address when the member logs into the system. Then, if a query is received (e.g., for temporary IP addresses), the system may return an affirmative response only if the last log-in address both matches the query address and is fairly recent. Other example embodiments may require a more secure system, where the user may be required to log in or authenticate their identity on a machine accessing participating content provider 1120. In response to an identifying query from the content provider, the example system may return a response, and if affirmative, may send along a matching ad. A matching ad may include one with one or more of the following characteristics: (1) offered at a price greater than the member's ask price, (2) format compatible with the content provider's ad space, and/or (3) offered for that member or with dataset criteria for which the member's dataset matches.

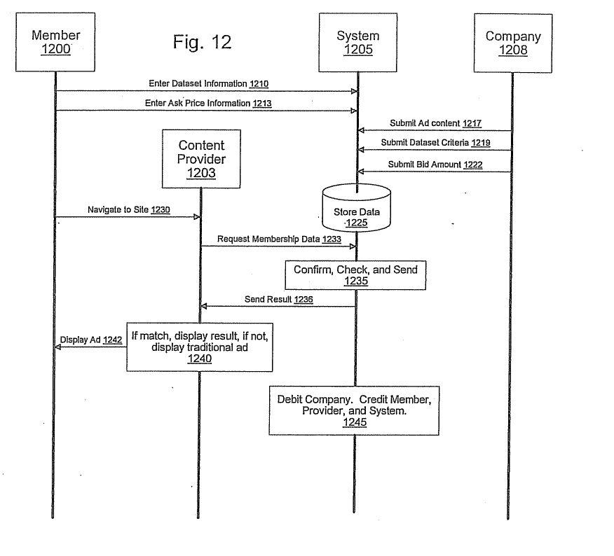

FIG. 12 may illustrate an example embodiment of this procedure. As was previously described in other example embodiments, a member 1200 may enter a set of data 1210. Further, that member 1200 may enter ask price information 1213. This may be the price at which that member is willing to accept targeted advertising. The member may be allowed to enter many different kinds of ask prices. For example, a member might specify a very low number for ads displayed in the same place and same manner as conventional ads. If a member will be browsing that content anyway, the member may rather receive a fraction of a penny instead of nothing. The member may specify a higher price for an expanding ad, especially for one that replaces a non-expanding conventional ad. When watching ad based video content, the member may specify a very low ask price for video ads of the same length and quantity of what would conventionally be shown, but specify a higher amount for longer ads or more frequent ads, as compared to the conventional ads.

Next, company 1208 may submit ad content at 1217. This may be audio/video data (e.g., a fifteen second add to display during a TV show), a banner ad, a keyword ad, or any other content the company will pay to present to a user. At 1219, the company may submit dataset criteria. This may include specifying who should see the ad, e.g., males aged 18 to 24 with verified incomes over fifty thousand per year. At 1222, the company may submit bid information, which may include how much the company is willing to pay to present this ad. This information may include a plurality of sets, e.g., up to $0.50 for a certain data set and up to $0.75 for a different, more desirable dataset, etc. Either as part of these submissions or separately, the company may also provide information about how long the campaign should last. For example, the company may specify a certain number of clicks, a certain monetary budget, or a certain number of impressions, or any number of other criteria the company may want to enter that determines an automatic disabling of the campaign, until otherwise specified.

The system 1205 may store all this data from member 1200 and company 1208, e.g., at data store 1225. The data may then be used to match member ask data with company offer data in the context of presenting the content 1217. For example, the member 1200 may visit some content provider 1203, e.g., by navigating to a site 1230. The content provider 1203 may be configured to display an advertisement or other revenue generating presentation. The content provider 1203 may be a member of system's 1205 outside network. At 1233, the content provider may pass along any identifying information received from member 1200 at 1230, to the system 1205. The system 1205 may then determine if the member 1200 is a member of the system 1205. At 1235, the system may confirm the member's identity, check for available ads/displays in data store 1225, and send a result back to the content provider 1203, e.g., at 1236. This result may be an indication that no match was found, which may cause content provider 1203 to display a conventional ad, e.g., at 1240 and 1242. The result may be a confirmation of identity and presentable content, e.g., from data store 1225. Additionally, if the member's identity is confirmed, but no matching content is found, e.g., insufficient dataset data or too high of a minimum ask price, the system may indicate a solution. In this case, the content provider might display an invitation to enter more information. The ad display area could simply be a question, “how old are you?” with an entry box. This may be especially useful if system 1205 determines that a first ad matches the member's dataset except that this ad requires a minimum age of 25 and the member has not entered this information. Additionally, if there is a second ad that matches the member's dataset except that the second ad requires a maximum age of 40, the system may determine that answering this question will result in at least one (and maybe two) matching ads for subsequent display. After the user enters the data, the system may provide a matching ad, or may revert to a conventional display if no matching ad results. In the member 1200 matches ads, except the member's minimum ask price is higher than the maximum offer price of a matching ad, the content provider may display a message, “Click here for $0.10.” Alternatively, the content provider may display the conventional ad, but also display (e.g., under that ad) a message and button, “Ads available at $0.10, click here to accept,” or “click here to change ask price,” etc. Finally, at 1245, the system may remove a certain amount from the company's budget, and compensate the relevant parties, according to some pre-determined arrangement. Since the company to user matching may be highly targeted, the compensation per ad may be much higher than a conventional ad. Thus, profit sharing with the content site may incentivize that site to encourage system members (e.g., 1200) to qualify for system ads, instead of conventional ads. Ads may also have escalating interaction and/or compensation. For example, an ad may be displayed (e.g., as a standard dataset and bid/ask price match) with a button for greater interaction, e.g., “click here to learn more and receive $0.25.”

In another example embodiment, users may be able to display messages to other users, using the third party content sites, or other participating forums. For example, a first user may use tools and forms provided in the user interface to upload or create a personal message to another user. The personal message may be a happy birthday message. The first user may pay a fee, e.g., similar to the companies, and the second user may see the happy birthday message on all or some of the participating third party content sites. These too may include banner ads, video messages, etc. The first user may also purchase and deliver a gift for the second user. Here, a happy birthday message may include a sub-message, e.g. user <name> bought you a gift card to <online retailer>, please click here to accept. Users may choose to put their name or remain anonymous. Users may also purchase gifts for off-line products/services. The receiving user may be required to click an acceptance button, e.g., to ensure the message was displayed to the user (e.g., to ensure the user visited a participating site that day). Additionally, gifts may remain waiting for the user, e.g., without the need of an accept button, and/or gift messages may be delivered after the actual birthday, if the first user specifies this via the interface.

Payment for this feature may be the same as if a company was paying to lease the second user's data, with the usual payment sharing proportions. Alternatively, based on the second user's settings, some or all of the amount that would eventually go to the second user may be waived for ads issued by other users. In one example embodiment, users may specify other users as within their connected group (e.g., by importing a friends list from a social networking site). A user may then set permissions for these users with regard to receiving messages via the system from those users. Users may also send messages to groups of other users. For example, the happy birthday message may be displayed to the second user and all connected friends of the second user. The message may include information about a birthday party, or may disseminate other information to the second user's connected group.

Individual users may also send messages to other users who are not within their group of friends. In this respect, the individual may be acting like a company, but may have a different interface and may have alternative fees for such messages. For example, a user may not be in the business of advertising to consumers, but may have an item for sale (e.g., their car), the user may be able to create and display an add to certain targeted individuals who have stated a purchase intention matching the user's car that is for sale. The example system may provide other tools for member to member sales, such as an online auction or best-offer management tool, for dealing with multiple responses, if multiple users received the targeted offer.

The bid/ask matching and compensation system may work in a number of ways, depending on chosen configuration. For example, assume a first member enters a minimum asking price of $0.10, a second member enters a minimum asking price of $0.20, and a company enters a maximum offer price of $0.50. The system may provide a member-favored system, where each matching member is paid the maximum offer price. In this example configuration, both members would be paid $0.50. The system may provide a company-favored system, where each matching member is paid their stated ask price. In this example configuration the members would be paid $0.10 and $0.20 respectively. The system may provide a highest-member favored system, where each matching member is paid the highest matching ask price. In this example configuration the members would each be paid $0.20. The system may provide an average payment, where each member is paid some amount between the ask and offer price. In one example configuration, the first member might be paid $0.30, while the second member may be paid $0.35. In these configurations, other provisions may be required to compensate the system and/or outside content providers. This may include membership fees for the companies, or an added fixed or percent fee for each transaction on the system. For example, users may be paid some percent (e.g., 95%) of their compensation, with the remainder going to the system as a service fee. Alternatively or additionally, companies may have to pay a percent fee, like a sales tax, on each transaction or on a one time budget submission. Alternatively or additionally, there may be a bid/ask spread similar to financial markets, where a user may specify some ask (e.g., $0.45) and only higher offers will match (e.g., $0.50). In this case, the bid-ask spread is a fixed amount that goes to the system as a service fee. Alternatively, the system may collect the entire spread, such that in the two member example above, the members would be paid $0.10 and $0.20 respectively, while the company may be charged $0.50 for both, with $0.70 going to the system. Any alternative arrangement or combination of arrangements may also be possible. Discounts may be given to companies that share verification information. Discounts may be given for certain desirable companies, e.g., a system operator may determine that more video ad content participation is desirable, and may offer a discount of those advertisers. The system may split a service fee with content provider 1203, or may decide to pass the entire service fee onto content provider 1203, e.g., to encourage participation and system growth.

In one example embodiment, the content provider 1203 may also specify criteria, such as the nature of the content, and the size of their commission. Thus, a match may only occur if the member's ask price, plus the provider's ask price are together lower than the company's offer price. Content may encompass not just video content, but also games, applications, services, etc. An individual may be allowed to tailor the experience, in view of the content costs vs. available compensation. For example, in one embodiment, an individual may first choose content based on the price of the content. One television show may cost a certain amount, while other shows may require a different amount. The user may be informed on this when selecting which show to view. That show may then be offered commercial-free, and the member's account may be debited in favor of the content provider 1203. The member/user may also decide to watch the show with some number of advertisements (e.g., 3), which may make the show free to view. The member/user may decide to watch the show with some other number of advertisements (e.g., 5), which may give the user a credit during the show. Additionally, those members with higher value scores, may require fewer commercials during a show, since their data may be worth more, and thus companies 1208 may offer more to show a commercial. In one example embodiment, content provider 1203, in conjunction with system 1205, may ask a user for more information. For example, the system may ask, (1) do you want to pay for this show, (2) do you want to view this show with four commercial breaks, (3) do you want to enter this missing personal data to reduce the number of commercial interruptions, etc.

In one example embodiment of the present invention, members may be given an offer interface. FIGS. 9 and 10 illustrate two such examples. The offer interface may provide a member varying opportunities to perform some action a company desires, for some agreed upon price. Members may sort their offers by offer-price, and companies may be incentivized to make larger offers. Even if enough members match the company's dataset criteria and minimum bid amount, those members may never get to lower offers, if they have enough higher offers to fill their available time. In one example embodiment, offers may have a time estimate to them (e.g., how long it takes to engage with the offer). Members may then choose to sort by which offer has the highest yield, e.g., dollar offer per time period required. Time estimates may be specified by the companies and verified and/or originally calculated by an average of how long prior customers took to complete the same or similar offer.

Offers may be similar to those described in example embodiments, e.g., print or video advertising. Offers may also be a survey, a single question, a product test (e.g., a link to a user interface with instructions to perform some task so the company may record how many users were unable to figure out the interface). Companies using the example platform may have the ability to target specific questions to a target group of consumers. Question targeting may also allow a company to ask a single question or a stream of questions to a user or group of users via the different distribution channels and offer interfaces of the various example embodiments. Question targeting may have built-in monetary incentives for the target group to engage. For example, if a lawnmower company wanted to ask his target group a question like “How often do you mow your lawn?”, it may choose to deliver that question to users in his target group via their offer interface, or through a banner ad on a website of a publisher-partner (e.g., content provider 1203), or by a direct message to the user's offer inbox. A company may also decide to ask a stream of questions to obtain their desired target group. For example, the lawnmower company may follow up the initial question by first targeting the responses that indicate “at least once a week,” with a second question, “How old is the lawnmower you currently own?” Responses to this second question indicating “three years or more” may become the company's target group to either receive a further question or to receive an ad and/or offer. Follow-up questions and/or streaming questions may be presented one after another, or may be spaced out over a longer period of time.

Offers may also be facilitated by a system message center, which may be a web-based email platform between brands and individuals. This may allow the system to track offers delivered to an individual by brands and receipts of purchases by the individual on an external e-commerce site. For example, a company may send a message to an individual with a monetary incentive for the individual to read the message or to take actions (go to his site, fill out a survey, make a purchase, etc.). The monetary incentive may then be deposited into the individual's account when the message is opened. Furthermore, the example system may be able to verify an individual's action with a brand (e.g., a purchase from the company's e-commerce site, or a survey completion on an external site, etc.) by receiving an acknowledgement in the form of an e-mail invoice from the brand, which the system may automatically read anonymously to verify that the action did take place. This can be done by the system sending out a “spider” to read the message for a confirmation code or certain keywords that confirm the action. Once the example system has verified the action, the action fee for the individual may be paid. These messages between brand and user may remain anonymous, e.g., as was discussed in the context of other example embodiments.

Another function of an example embodiment may include a brand relationship management center. Managing brand relationships may be a core function of this example embodiment. It may present an important benefit for companies because of increased efficiency for companies to target messages to members that already want to be affiliated with their brands. The brand relationship management center may, among other things, allow companies to direct better offers, to cross-sell and up-sell their products and brands, and to develop deeper loyalty programs, with customers who they have already convinced to use their brands. Additionally, consumers may, as members of the system, be able to efficiently communicate with the brands they choose to have relationships with. For example, a member who has just moved may wish to communicate a change in address to the brands that he uses, e.g., his newspaper, his favorite retailer or his favorite social networking site, but instead of having to access three separate sites to make an address change, he may make a single change on the system data interface, and that information may be conveyed directly to his favorite brands, through his brand relationship management center.

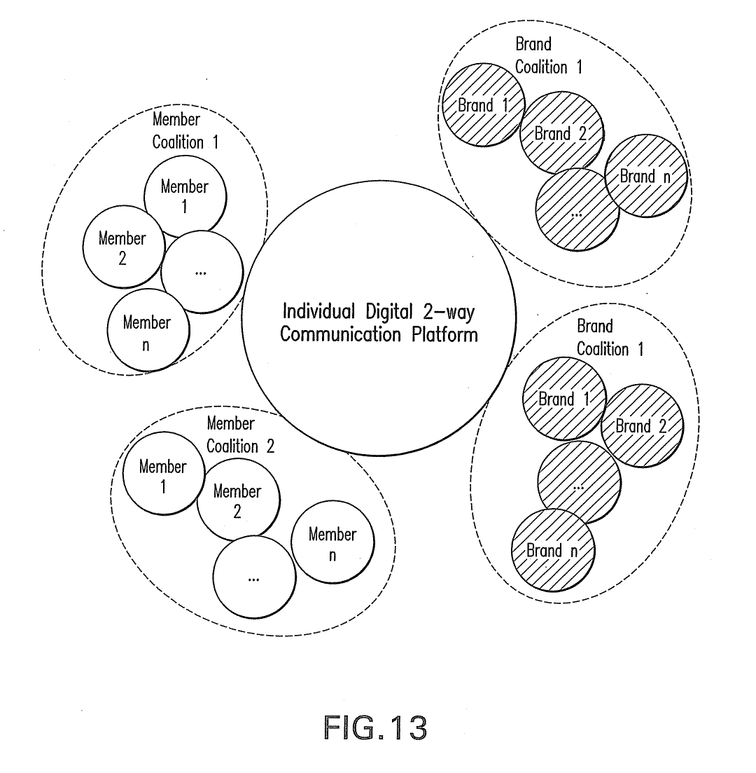

In one example embodiment of the present invention, users may be allowed to form coalitions, groups, associations, or any other similar organizing structure. FIG. 13 illustrates this concept, as compared to FIG. 1. Such groupings may be created for any number of reasons, e.g., an individual or a coalition of individuals may create individual pools or a shared pool of money (e.g., a pool of micropayment dollars). These pools may be designated for a particular cause or charity. A pool of dollars may be created by various entities, e.g., a member, a brand or a charity. If it is shared, individuals and brands can then choose to participate and send a portion of the payments collected on the system to this pool. Each member may have access to data regarding the pooled assets, including graphical metric data. For example, to engage the social and fun aspects of this pool of shared dollars, it may be represented in various graphical ways, e.g., a “growing mountain of pennies.” Users may be able to pledge all of their earnings, just a certain category of earnings, or a certain percentage of earnings.

Coalitions may form around one or more issues, in order to have a greater impact on communicating with a brand. For example, a group of users may form around an issue where the group members all believe some brand is engaged in unacceptable labor practices. This by itself may provide more communication effect than other boycott/protest efforts. Additionally, the group members may choose to release their personal information to form a group characteristic. This way, where the brand may have assumed the boycotters and protesters were not their customers or in their target demographic anyway, the brand may be able to now see verified data that the group includes some number of target demographic customers and contains some number of verified previous customers. The group dynamic may create a stronger voice than a mere headcount would, by making that voice relevant to a verifiable degree to the target brand.

Likewise, the brand members of example embodiments may utilize the system alone or in brand coalitions/groups. An online publisher may be a content provider, and may rely on advertising or subscription fees to support its business model. Publishers can exist both online (e.g., websites like Yahoo.com, NYTimes.com, Foxnews.com, or various blogs) and offline (e.g., magazines, newspapers, TV networks, cable content providers, etc.). Today, large premium online publishers like Yahoo.com or NYTimes.com utilize a combination of an internal sales force to sell premium advertising space on their web pages, and ad-exchanges/ad-networks for less prominent web pages. Conventionally, publishers may sell advertising oriented to the demographic that their content attracts. For example, a sports website might sell advertising space on its website to advertisers who are interested in reaching its sports-focused and male-centric readers. If the publisher is part of an example system described herein, then the universe of relevant advertisers may become automatically larger, because the publisher may now be able to sell his advertising space, not against the content of his channel, but against the individual reader. To continue with the example of a sports site, if this site is a member of the system, and a female reader/system-member, who is in the market for a new handbag but who is not a “typical” reader of the site, may still be able to get relevant ads for her stated intention to purchase a handbag. Similarly, the mismatch of content based on a stereotypical user and the actual user may not necessarily be so pronounced. Even offers tailored to a statistically probable user, may be wastefully mismatched with a minority but still significant segment of the audience.

Example embodiments of systems may be built and implemented using any number of system technology capable of facilitating the claimed subject matter. For example, one or more computer servers, in one or more physical locations, may provide a platform for example embodiments of example systems. User interfaces and company interfaces may include personal computers, laptops of any size, smart phones, cellular phones, virtual machines, or any other device capable of providing a user/member interface to an example embodiment. Example methods of the present invention may be run on various computer systems, e.g., those mentioned above.

It will be appreciated that all of the disclosed methods and procedures described herein can be implemented using one or more computer programs or components. These components may be provided as a series of computer instructions on any conventional non-transitive computer-readable medium, including RAM, ROM, flash memory, magnetic or optical disks, optical memory, or other storage media. The instructions may be configured to be executed by a processor which, when executing the series of computer instructions, performs or facilitates the performance of all or part of the disclosed methods and procedures.

An example embodiment of the present invention is directed to a method, e.g., of a hardware component or machine, of transmitting instructions executable by a processor to perform the methods described herein.

The above description is intended to be illustrative, and not restrictive. Those skilled in the art can appreciate from the foregoing description that the present invention may be implemented in a variety of forms, and that the various embodiments may be implemented alone or in combination. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and following claims. Indeed, it should be understood that there exist implementations of other variations and modifications of the invention and its various aspects, as may be readily apparent to those of ordinary skill in the art, and that the invention is not limited by specific embodiments described herein. Features and embodiments described above may be combined. It is therefore contemplated to cover any and all modifications, variations, combinations or equivalents that fall within the scope of the basic underlying principals disclosed and claimed herein.

What is claimed is:

1. A data market system, comprising:
a server including an electronic computer with an electronic processing unit, wherein:
the server includes:
a user interface configured to receive data from a user, about that user;
a verification module configured to perform a verification of at least some of the received data with an independent source;
a value scoring module configured to calculate and associate a value score with the user based on the data received from the user and a result of the verification; and
a company interface configured to receive match criteria and offer content; and
the processing unit is configured to:
identify a match between the received data and the match criteria; and
responsive to the match, provide the user the offer content associated with the match criteria.

2. The data market system of claim 1, wherein the system is configured to operate for a plurality of users and a plurality of companies, wherein each user enters multiple pieces of data in multiple sessions, wherein each company provides multiple offers, each with associated match criteria, and wherein the multiple offers are of multiple types.

3. The data market system of claim 1, wherein the data from the user includes at least one of:
data provided by the user, describing the user;
data provided by the user describing products the user intends to purchase; and
data provided by the user granting permission to passively collect data, wherein the passively collected data is associated with the user.

4. The data market system of claim 1, wherein the data from the user includes a minimum asking price for receiving some offer.

5. The data market system of claim 4, wherein there are several types of offers, and the data from the user includes a minimum asking price for receiving each type of offer.

6. The data market system of claim 1, wherein match criteria include a maximum bid price an associated company will pay to present a matching user with the offer content.

7. The data market system of claim 1, wherein the user interface and company interface are configured to facilitate a leasing of user data for a fee.

8. The data market system of claim 1, wherein the offer content includes at least one of: a visual advertisement, an audible advertisement, an audiovisual advertisement, a survey, a single question, and a navigation link.

9. The data market system of claim 1, wherein the match is based on at least an ask price from the user and an offer price from a company, and wherein the server is configured to, responsive to the user meeting a set of offer requirements, credit the user a degree of compensation based at least in part on a bid or an offer price.

10. The data market system of claim 1, further comprising:
a third party content interface configured to:
receive identity information from a third party partner for an outside user;
check the identity information against user data stored in the system; and
send back a result of the check, including:
responsive to the identity information matching a system user and responsive to the system user having offer content with matching criteria, wherein the offer content is capable of being presented by the third party partner, sending the offer content to the third party partner.

11. A method of targeted advertising, comprising:
maintaining a database of conventional advertising content configured to be provided to any user;
providing advertising content in conjunction with non-advertising content to a plurality of users, including, for each respective user:
determining identification information about the respective user;
forwarding the identification information to a membership verification module of a targeted-advertising system;
receiving a result from the membership verification module;
where the result indicates non-membership, responsive to the result, providing the conventional advertising content to the user; and
where the result indicates membership, responsive to the result, receiving user-specific advertising from the targeted-advertising system and providing the user-specific advertising.

12. The method of claim 11, wherein the non-advertising content is textual, wherein the advertising content is a graphic banner ad displayed on a page with the textual content, and wherein the user-specific advertising is a similarly sized graphic banner ad configured to replace the graphic banner ad.

13. The method of claim 12, wherein the user-specific advertising is a banner ad including a question and a data entry area.

14. The method of claim 13, wherein the user is compensated when the banner ad is displayed, and further compensated responsive to entering data in the data entry area.

15. The method of claim 11, wherein the non-advertising content is a video program with at least one advertising point configured to display a still graphic or video for a period of time upon reaching the at least one advertising point.

16. A computer-implemented method of facilitating a data market and providing an information distribution ranking score, comprising:
receiving, by a computer processor, initial data describing a user previously obtained or determined;
calculating, by the processor, a value score for the user, based on the initial data;
receiving, by the processor, subsequent data describing the user;
receiving, by the processor, intent data describing an intent of the user to make a purchase within a product category;
determining, by the processor, if the user followed through with the purchase;
adjusting, by the processor, the value score, based on the subsequent data, based on the intent data, and based on a result of the determining; and
outputting, by the processor, the value score.

17. The method of claim 16, further comprising:
displaying a first subset of data associated with the user;
obscuring a second subset of data associated with the user; and
providing a selectable option to reveal the second subset of data, such that all data associated with the user is displayable to the user either by default or upon user command.

18. The method of claim 16, further comprising:
providing a selectable option to delete a piece of data; and
responsive to selection of the selectable option:
deleting the piece of data; and
adjusting the value score.

19. The method of claim 18, further comprising:
providing a selectable option to delete every piece of data.

20. A targeted advertising system for a plurality of users and companies, comprising:
a platform server with an electronic processor configured to receive data from a user about that user, wherein the electronic processor is configured to:
provide, via a user interface, management tools that provide the user control of the data; and
receive match criteria from companies defining a target customer;
a matching server configured to match one or more matched users and a company based on the match criteria and the data; and
a message server configured to provide user-anonymity to matched users while facilitating communication between the company and the matched users.
